(19) United States
(12) Patent Application Publication
(10) Pub. No.: US 2021/0279586 A1
(43) Pub. Date: Sep. 9, 2021

(54) METHOD AND APPARATUS FOR CLIPPING NEURAL NETWORKS AND PERFORMING CONVOLUTION

(71) Applicant: Samsung Electronics Co., Ltd., Suwon-si (KR)

(72) Inventors: CongCong HE, Xi'an (CN); Jian ZHAO, Xi'an (CN); Min YANG, Xi'an (CN); Peng LEI, Xi'an (CN)

(73) Assignee: Samsung Electronics Co., Ltd., Suwon-si (KR)

(21) Appl. No.: 17/190,642

(22) Filed: Mar. 3, 2021

(30) Foreign Application Priority Data
Mar. 3, 2020 (CN) 202010140843.7
Feb. 16, 2021 (KR) 10-2021-0020655

(51) Int. Cl. G06N 3/08; G06K 9/62

(52) U.S. Cl. CPC G06N 3/082; G06K 9/6232; G06K 9/6228; G06K 9/6215

(57) ABSTRACT

Methods and apparatuses of clipping a neural network and calculating a convolution of a neural network are provided. A method of clipping a neural network includes selecting a kernel slice of an input channel of a convolution layer in the neural network based on a convolution parameter of the convolution layer, determining a kernel slice similar to the selected kernel slice, determining a substitute slice for the selected kernel slice, based on the similar kernel slice, and clipping the selected kernel slice and replacing the clipped kernel slice by the substitute slice. The convolution parameter may include a number of input channels of the convolution layer, a number of output channels, and a width and a height of a filter of a convolution kernel of the convolution layer.

### CROSS-REFERENCE TO RELATED APPLICATIONS

This application claims the benefit under 35 USC 119(a) of Chinese Patent Application No. 202010140843.7, filed on Mar. 3, 2020, in the China National Intellectual Property Administration and Korean Patent Application No. 10-2021-0020655, filed on Feb. 16, 2021, in the Korean Intellectual Property Office, the entire disclosures of which are incorporated herein by reference for all purposes.

### BACKGROUND

### Field

The following description relates to a lightening of a neural network, and to clipping a neural network and performing a convolution in the clipped neural network.

### 2. DESCRIPTION OF RELATED ART

A convolutional neural network (CNN) may be compressed so that it takes up lesser space for storage, and method of clipping the neural network may be used for the compression. After a CNN is trained, a weight close to “0” or a threshold may be retrieved and clipped. An index of the clipped weight may be stored as index information. However, since weights are randomly clipped, a simple clipping method requires a large amount of additional reference space to store indices of the clipped weights. When the clipped weights are in an irregular form, it may be difficult to access the weights during inference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a processor-implemented method of clipping a neural network, the method including selecting a kernel slice of an input channel of a convolution layer in the neural network based on a convolution parameter of the convolution layer, determining a kernel slice similar to the selected kernel slice, determining a substitute slice for the selected kernel slice, based on the similar kernel slice, and clipping the selected kernel slice and replacing the clipped kernel slice by the substitute slice, wherein the convolution parameter comprises a number of input channels of the convolution layer, a number of output channels, and a width and a height of a filter of a convolution kernel of the convolution layer.

The method may include storing an index of the clipped kernel slice.

The determining of the similar kernel slice may include calculating norms of kernel slices for each of the input channels of the convolution layer, and determining a kernel slice similar to the selected kernel slice, based on the norms.

The determining of the kernel slice similar to the selected kernel slice may include classifying kernel slices of the input channels into at least one class based on the norms, and determining a kernel slice from among kernel slices within a class of the selected kernel slice based on a similarity between the selected kernel slice and each of the kernel slices within the class.

The determining of the kernel slice based on the similarity may include determining the similarity by calculating a norm of a difference between the selected kernel slice and each of the kernel slices within the class, and determining a kernel slice having a similarity to the selected kernel slice lesser than or equal to a threshold, as the similar kernel slice.

The determining of the substitute slice may include calculating an average kernel slice by averaging the selected kernel slice and the similar kernel slice, and replacing any one or any combination of the selected kernel slice and the similar kernel slice by the average kernel slice.

The selecting of the kernel slice may include determining a number of kernel slices based on the number of input channels, and extracting the kernel slice of the input channel from a tensor representing the convolution kernel based on the number of kernel slices and the convolution parameter.

In another general aspect, there is provided a method of convolution of a neural network, the method including determining whether a kernel slice of each input channel is a substitute slice, based on index information of a convolution layer included in the neural network, obtaining an index of the substitute slice from the index information, in response to the kernel slice being the substitute slice, and calculating a convolution based on the index of the substitute slice, wherein a first kernel slice, similar to a second kernel slice, selected based on a convolution parameter of the convolution layer is clipped and replaced by the substitute slice.

The method may include performing a convolution on the kernel slice using an index of the kernel slice, in response to the kernel slice not being the substitute slice.

The method may include outputting a cumulative value obtained by accumulating results of the calculating of the convolution and the performing of the convolution for kernel slices of input channels of the convolution layer as an output of the convolution layer.

In another general aspect, there is provided an electronic apparatus including a processor configured to select a kernel slice of an input channel of a convolution layer in a neural network based on a convolution parameter of the convolution layer, determine a kernel slice similar to the selected kernel slice, determine a substitute slice for the selected kernel slice, based on the similar kernel slice, and clip the selected kernel slice and replace the clipped kernel slice by the substitute slice, wherein the convolution parameter comprises a number of input channels of the convolution layer, a number of output channels, and a width and a height of a filter of a convolution kernel of the convolution layer.

The processor may be configured to classify kernel slices of the input channels into one or more classes based on the norms of kernel slices for each of the input channels of the convolution layer, and determine a kernel slice, from among kernel slices within a class of the selected kernel slice, to be the similar kernel slice based on a similarity between the selected kernel slice and each of the kernel slices within the class.

In

Other features and aspects will be apparent from the following detailed description, the drawings, and the claims.

### BRIEF DESCRIPTION OF THE DRAWINGS

FIG. 1 is a diagram illustrating an example of a method of clipping a neural network.

FIG. 2 illustrates an example of a method of clipping a neural network.

FIG. 3 illustrates an example of extracting a kernel slice in a method of clipping a neural network.

FIG. 4 illustrates an example of classifying kernel slices in a method of clipping a neural network.

FIG. 5 illustrates an example of determining a similarity between kernel slices belonging to the same class in a method of clipping a neural network.

FIG. 6 illustrates an example of clipping a kernel slice similar to a selected kernel slice in a method of clipping a neural network.

FIG. 7 is a diagram illustrating an example of a method of calculating a convolution of a neural network.

FIG. 8 illustrates an example of a general convolution operation.

FIG. 9 illustrates an example of a method of calculating a convolution of a neural network.

FIG. 10 illustrates an example of a configuration of an electronic apparatus.

FIG. 11 illustrates an example of a configuration of an electronic apparatus.

FIG. 12 illustrates an example of a configuration of an electronic apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. As used herein, the term “and/or” includes any one and any combination of any two or more of the associated listed items. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

The use of the term “may” herein with respect to an example or embodiment (e.g., as to what an example or embodiment may include or implement) means that at least one example or embodiment exists where such a feature is included or implemented, while all examples are not limited thereto.

Hereinafter, examples will be described in detail with reference to the accompanying drawings, and like reference numerals in the drawings refer to like elements throughout.

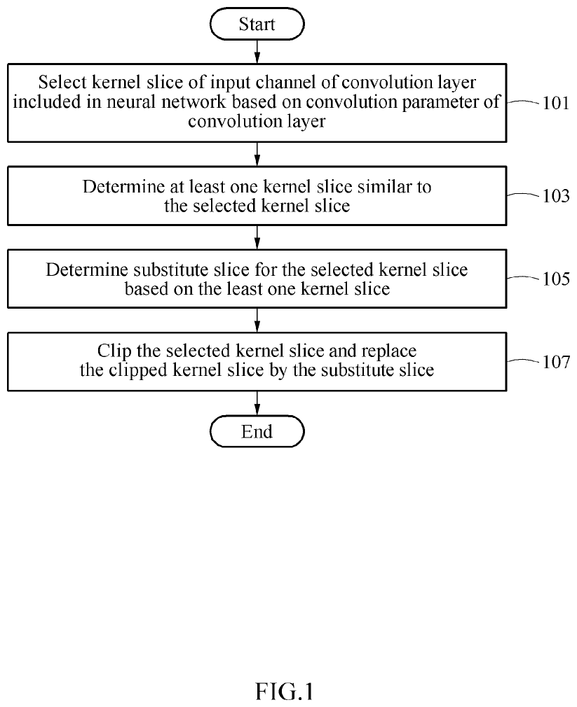

FIG. 1 is a diagram illustrating an example of a method of clipping a neural network. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently. One or more blocks of FIG. 1, and combinations of the blocks, can be implemented by special purpose hardware-based computer, such as a processor, that perform the specified functions, or combinations of special purpose hardware and computer instructions.

Computing devices that are referred to as performing the clipping operation, may also perform convolution, or may perform clipping or convolution alone. Likewise, reference to computing devices that perform the convolution operation may also perform clipping, or clipping or convolution alone.

In an example, an electronic apparatus may clip a kernel slice of a convolution layer of a trained neural network. The electronic apparatus may reduce a storage space and complexity of kernel slices by replacing a kernel slice substitute slice, which is similar to the kernel slice. The electronic apparatus may reuse an index of the clipped kernel slice as a substitute slice. Hereinafter, clipping may also be referred to as “pruning”.

Referring to FIG. 1, in operation 101, the electronic apparatus may select a kernel slice of an input channel of a convolution layer included in a neural network based on a convolution parameter of the convolution layer. For example, the electronic apparatus may determine a number of kernel slices based on a number of input channels. The electronic apparatus may extract the kernel slice of the input channel from a tensor representing a convolution kernel of the convolution layer, based on the determined number of kernel slices and the convolution parameter. The convolution parameter may include, for example, a number of input channels of the convolution layer, a number of output channels, and a width and a height of a filter of the convolution kernel.

In operation 103, the electronic apparatus may determine at least one kernel slice similar to the selected kernel slice.

In an example, the electronic apparatus may calculate norms of kernel slices for the input channels of the convolution layer.

In an example, the electronic apparatus may determine at least one kernel slice similar to the selected kernel slice, based on a norm of a kernel slice of each input channel. The electronic apparatus may classify kernel slices of input channels into at least one class based on a norm of a kernel slice of each input channel. The electronic apparatus may determine at least one kernel slice similar to the selected kernel slice. The similar kernel slice may be selected based on a similarity between the selected kernel slice and each of at least one kernel slice that are classified in a class to which the selected kernel slice belongs.

In an example, the electronic apparatus may determine the similarity by calculating a norm of a difference between the selected kernel slice and each of the at least one kernel slice classified in the class to which the selected kernel slice belongs. In an example, the electronic apparatus may determine a kernel slice, of which a similarity to the selected kernel slice is less than or equal to a threshold, as a kernel slice similar to the selected kernel slice. The electronic apparatus may calculate a similarity for each class, and thus resources and time required for calculation of the similarity may be saved.

In operation 105, the electronic apparatus may determine a substitute slice for the selected kernel slice, based on the least one kernel slice similar to the selected kernel slice. In an example, the electronic apparatus may calculate an average kernel slice by averaging the selected kernel slice and the at least one kernel slice. The electronic apparatus may replace any one or any combination of the selected kernel slice and the at least one kernel slice by the average kernel slice. In another example, the electronic apparatus may replace any one or any combination of the selected kernel slice and the at least one kernel slice by another one or another combination of the selected kernel slice and the at least one kernel slice.

In operation 107, the electronic apparatus may clip the selected kernel slice and replace the clipped kernel slice by the substitute slice. In an example, the electronic apparatus may store an index of the clipped kernel slice.

In an example, the electronic apparatus may efficiently alleviate spatial complexity and storage space problems of a convolutional neural network (CNN) without additional reference space by clipping a similar kernel slice. Thus, it is possible to efficiently mitigate spatial complexity and a storage space needed by a convolutional neural network (CNN) even though an additional reference space is absent. By clipping the kernel slice similar to the selected kernel slice, instead of clipping a storage space occupied by a preset weight in the neural network, the electronic apparatus may reduce space complexity of the neural network and a storage space needed by a convolution layer. The electronic apparatus may clip a weight of the CNN regardless of an expression form of the weight.

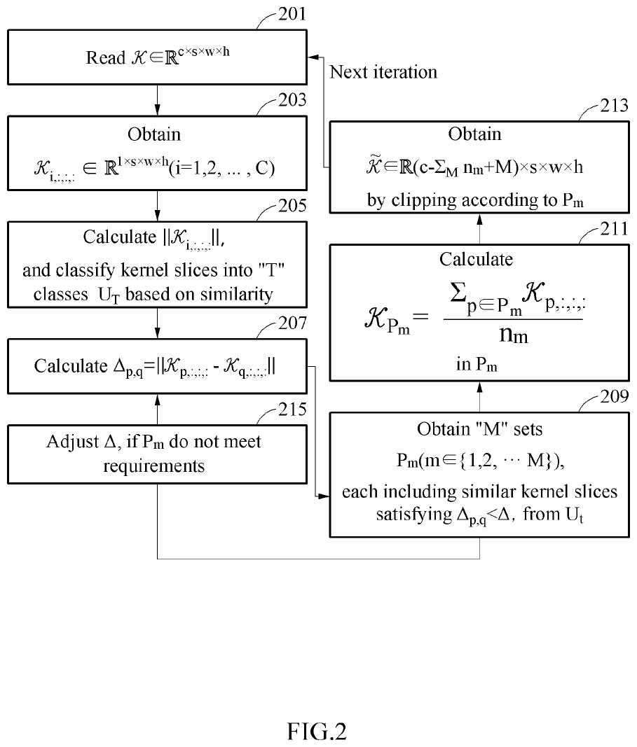

FIG. 2 illustrates an example of a method of clipping a neural network.

An electronic apparatus may clip an input channel for a neural network that is trained. The neural network may be, for example, a deep neural network (DNN) and may include a convolution layer. Hereinafter, the neural network may be denoted by N.

In operation 201, the electronic apparatus may obtain information of the neural network N. The electronic apparatus may read a kernel [symbol] ϵ [symbol] ^{C×S×w×h} of a first convolution layer of the neural network N, and may obtain a convolution parameter of the first convolution layer. The convolution parameter may include a number C of input channels, a number S of output channels, and a width w and a height h of a convolution filter. The first convolution layer may be a first convolution layer based on a forward direction in which input data passes through the neural network.

In operation 203, the electronic apparatus may obtain information [symbol] _{i,:,:,:}ϵ [symbol] ^{1×S×w×h}(iϵ{1, 2, . . . C}) of kernel slices respectively corresponding to input channels “1” to “C”. The kernel [symbol] ϵ [symbol] ^{C×S×w×h} may be a four-dimensional (4D) tensor, and kernel slices may be [symbol] _{i,:,:,:}ϵ [symbol] ^{1×S×w×h}(iϵ{1, 2, . . . , C}) corresponding to each input channel. For example, a kernel slice may be a vector extracted from a matrix corresponding to a kernel of a convolution layer. The electronic apparatus may select a one-dimensional (1D) index “1” corresponding to an input channel with a length of “C” and may obtain a kernel slice E [symbol] ^{1×S×w×h} including all possible combinations of S, w and h. Subsequently, the electronic apparatus may select a 1D index “2” corresponding to an input channel with a length of “C” and may obtain a kernel slice [symbol] _{2,:,:,:}ϵ [symbol] ^{1×S×w×h} including all possible combinations of S, w and h. As described above, the electronic apparatus may obtain kernel slices by repeating the above process from 1D indices “1” to “C”.

In operation 205, the electronic apparatus may calculate a norm ∥␣_{i,:,:,:}∥ for “C” kernel slices [symbol] _{i,:,:,:}. The electronic apparatus may classify kernel slices with similar norms by classes by comparing magnitudes of norms of kernel slices of “C” input channels. For example, kernel slices may be classified as one of classes, for example, U₁, U₂, and U_{T}.

When a norm ∥ [symbol] − [symbol] ∥ of a difference between kernel slices is used, a similarity between tensors A and B with the same size may be calculated, however, a norm of a difference between kernel slices of two input channels may require a large amount of calculation. In an example, the electronic apparatus may calculate a norm ∥ [symbol] _{i,:,:,:}∥ of a kernel slice of each input channel, and may perform temporary classification using a similarity between norms of kernel slices. In this example, kernel slices belonging to the same class may be similar, but kernel slices belonging to different classes may be different. The electronic apparatus may calculate a similarity between kernel slices in each class, to maintain a relatively high accuracy while saving resources.

In operation 207, the electronic apparatus may calculate a similarity between kernel slices belonging to the same class. A similarity Δ_{p,q} may be defined as a norm Δ_{p,q}=∥ [symbol] _{p,:,:,:}− [symbol] _{q,:,:,:}∥(tϵ{1, 2, . . . T}, pϵUₜ, qϵUₜ, p≠q) of a difference between kernel slices of different input channels in the same class, for example, Uₜ. For example, if the similarity Δ_{p,q} is less than a threshold Δ, and [symbol] _{p,:,:,:} and [symbol] _{q,:,:,:} may be determined to be similar.

Operation 207 may be associated with operation 205, and the electronic apparatus may maintain a relatively high accuracy while saving resources by calculating only a similarity between kernel slices in the same class. The norm of the difference in operation 205 may be for preliminary determination, and the norm between kernel slices in operation 207 may be for accurate similarity determination. For example, a norm of a vector [1 2 3] and a norm of a vector [3 2 1] may be the same, but a norm of a difference between the above two vectors may be “4”.

In operation 209, the electronic apparatus may determine similar kernel slices of all input channels in each of “T” Uₜ, and may obtain “M^{(U}^{ₜ}⁾” sets. For example, a number of sets may be “M” and M=M^{(U}^{₁}⁾+M^{(U}^{₂}⁾+ . . . +M^{(U}^{_{T}}⁾. In each set Pₘ (mϵ{1, 2, . . . M}), indices of input channels corresponding to similar kernel slices of input channels may be stored. Kernel slices [symbol] _{i,:,:,:} and [symbol] _{j,:,:,:} of two input channels corresponding to indices i and j of the input channels in the same Pₘ may satisfy Δ_{i,j}<Δ. In a set P_{O}, indices of kernel slices that do not correspond to similar input channels among all Uₜ may be stored.

For each Uₜ, the electronic apparatus may extract a kernel slice [symbol] _{i,:,:,:} (iϵUₜ) of a lowest index of an input channel, and may calculate a similarity Δ_{i,j} between a kernel slice extracted in an order of indices and a kernel slice [symbol] _{j,:,:,:} (jϵUₜ,j≠i) of another input channel. The electronic apparatus may include the indices i and j of the input channels that satisfy Δ_{i,j}<Δ in the set Pₘ(1≤m<M), and may remove the indices i and j included in Pₘ from Uₜ. If a kernel slice [symbol] _{j,:,:,:} of an input channel satisfying Δ_{i,j}<Δ is not found, the electronic apparatus may include the index i in the set P_{O} and may remove the index I from Uₜ.

The electronic apparatus may extract a kernel slice [symbol] _{x,:,:,:} (xϵUₜ) of a lowest index of an input channel for next Uₜ, and may calculate a channel similarity Δ_{x,y} between a kernel slice extracted in an order of indices and a kernel slice [symbol] _{y,:,:,:} (yϵUₜ, y≠x) of another input channel. The electronic apparatus may include indices x and y of input channels that satisfy Δ_{x,y}<Δ in a set Pₘ₊₁, and may remove the indices x and y included in Pₘ₊₁ from Uₜ. If a kernel slice [symbol] _{y,:,:,:} of an input channel satisfying Δ_{x,y}<Δ is not found, the electronic apparatus may include the index x in the set P_{O} and may remove the index x from Uₜ. As described above, the above process may be repeated until Uₜ becomes an empty set, and “M^{(U}^{ₜ}⁾” sets, for example, sets Pₘ, Pₘ₊₁, and

$${P}_{m + {M}^{( {U}_{t} )} - 1} ,$$

may be obtained.

As a result of operation 209, “M” sets Pₘ(mϵ{1, 2, . . . M}) may be obtained. Each of the “M” sets may include indices of similar input channels among kernel slices included in a convolution kernel K. The set P_{O} may include an index of a kernel slice of an input channel that is not similar to any kernel slice. As described above, in operation 209, a kernel slice of an input channel to be clipped may be finally determined.

The electronic apparatus may perform clipping based on Pₘ and P_{O}. For each Uₜ, a comparison process may be performed in an ascending order of indices, starting from a lowest value among index values of input channels. Thus, a redundant comparison process that may occur after Uₜ is changed may be avoided. Not repeatedly recording an index of an input channel satisfying Δ_{i,j}<Δ or Δ_{x,y}<Δ may indicate that an element value of the set Pₘ or Pₘ₊₁ is not repeated, and otherwise, may indicate that kernel slices of input channels are similar to each other. If the set P_{O} and a quantity and a distribution of elements of “M” sets Pₘ fail to meet a preset quantity requirement and/or a distribution requirement, the method may revert to operation 207, and the threshold Δ may be adjusted in operation 215.

In operation 211, the electronic apparatus may traverse the sets Pₘ. When each of the sets Pₘ includes “nₘ” elements, the electronic apparatus may calculate an average kernel slice of kernel slices of input channels corresponding to all indices. “M” average kernel slices may be obtained. The electronic apparatus may calculate an average kernel slice using Equation 1 shown below.

$${𝒦}_{{P}_{m}} = \frac{{\sum }_{p ∈ {P}_{m}} {𝒦}_{p , : , : , :}}{{n}_{m}} \qquad \{ Equation 1 ]$$

In operation 211, the average kernel slice may be added, instead of a clipped kernel slice, as a new kernel slice of an input channel. The average kernel slice may be an average tensor of all input kernel slices in any Pₘ, and a dimension of the average kernel slice may be identical to that of a kernel slice [symbol] ^{1×S×w×h} of the original input channel. A number of [symbol] _{P}_{ₘ} and a number of Pₘ may be both “M” and the same number of average kernel slices as the number of Pₘ may be generated.

In operation 213, the electronic apparatus may traverse all the sets Pₘ. For each of the sets Pₘ, the electronic apparatus may clip kernel slices [symbol] _{p,:,:,:} of all input channels with indices of pϵPₘ in the original convolution kernel [symbol] ϵ [symbol] ^{C×S×w×h}. The electronic apparatus may include an average kernel slice [symbol] _{P}_{ₘ} corresponding to Pₘ, instead of the clipped kernel slice, in a corresponding kernel. The final convolution kernel may be [symbol] ϵ [symbol] ^{(C-Σ}^{_{M}}ⁿ^{ₘ}^{+M)×S×w×h}.

The convolution kernel [symbol] may be configured with kernel slices [symbol] _{s,:,:,:}ϵ [symbol] ^{1×S×w×h}(sϵ{1, 2, . . . , C−Σₘ nₘ+M}) of input channels, and may include “C−Σ_{M} nₘ+M” kernel slices in total. The convolution kernel [symbol] may include two portions. A first portion may be “C−Σ_{M} nₘ” kernel slices [symbol] _{q,:,:,:} (qϵP_{O}, q∈Pₘ) of input channels that are not clipped in the original convolution kernel [symbol] , and a second portion may be “M” average kernel slices [symbol] _{P}_{ₘ} that are newly added.

Clipped indices p among the original indices included in Pₘ may be assigned to the “M” average kernel slices [symbol] _{P}_{ₘ} in an ascending order. The electronic apparatus may record all Pₘ in a set U (PₘϵU) in the same order. After clipping, the original indices q recorded in the set P_{O} may be arranged in an ascending order.

When a next layer of a neural network [symbol] is a convolution layer after completion of operation 213, the method may revert to operation 201 and may be repeated for the next layer.

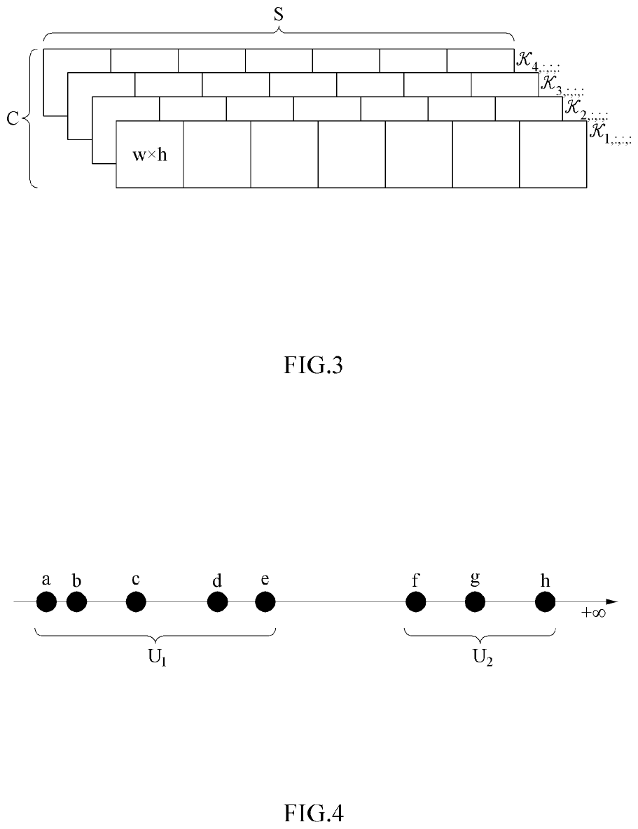

FIG. 3 illustrates an example of extracting a kernel slice in a method of clipping a neural network.

An electronic apparatus may obtain information [symbol] _{i,:,:,:}ϵ [symbol] ^{1×S×w×h}(iϵ{1, 2, . . . , C}) of kernel slices respectively corresponding to input channels 1 to C. In this example, a kernel [symbol] ϵ [symbol] ^{C×S×w×h} may be a four-dimensional (4D) tensor, and kernel slices may be [symbol] _{i,:,:,:}ϵ [symbol] ^{1×S×w×h}(iϵ{1, 2, . . . , C}) respectively corresponding to input channels.

Referring to FIG. 3, in the kernel [symbol] ϵ [symbol] ^{C×S×w×h} C is “4” and S is “7”. “S” convolution filters of each row may correspond to a kernel slice of a single input channel. A kernel slice may have a size of “1×7×w×h”, and kernel slices of input channels may be [symbol] _{1,:,:,:}, [symbol] _{2,:,:,:}, [symbol] _{3,:,:,:}, and [symbol] _{4,:,:,:}, respectively.

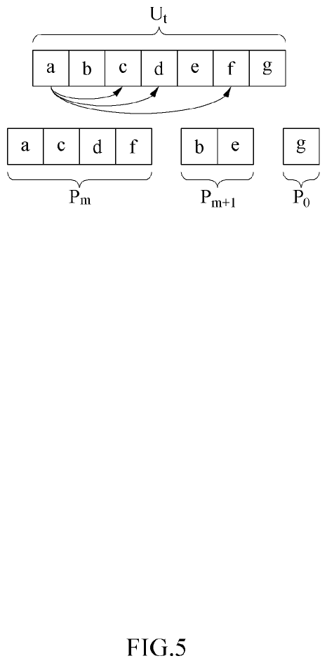

FIG. 4 illustrates an example of classifying kernel slices in a method of clipping a neural network.

An electronic apparatus may calculate a norm ∥ [symbol] _{i,:,:,:}∥ of “C” kernel slices [symbol] _{i,:,:,:}, The electronic apparatus may compare magnitude of norms of kernel slices of “C” input channels, and may classify kernel slices with similar norms by classes.

Referring to FIG. 4, an axis represents a dimension of an input channel, and kernel slices corresponding to “8” input channels are shown. In FIG. 4, a, b, c, d, e, f, g, and h may be indices of the kernel slices of the input channels. The kernel slices may be classified into two classes, for example, U₁={a, b, c, d, e} and U₂={f, g, h}, based on a similarity between norms. It may be found that kernel slices included in U₁ are different from kernel slices included in U₂.

FIG. 5 illustrates an example of determining a similarity between kernel slices belonging to the same class in a method of clipping a neural network.

An electronic apparatus may determine similar kernel slices of all input channels for each of “T” Uₜ, and may obtain “M^{(U}^{ₜ}⁾” sets. Referring to FIG. 5, Uₜ includes indices of seven input channels and the indices may be a, b, c, d, e, f, and g. The electronic apparatus may select a lowest index “a” and may calculate a relationship of Δ_{a,d}<Δ, Δ_{a,d}<Δ, Δ_{a,f}<Δ. The relationship may indicate that [symbol] _{a,:,:,:}, [symbol] _{c,:,:,:}, [symbol] _{d,:,:,:}, and [symbol] _{f,:,:,:} are similar to each other, and the electronic apparatus may include the indices a, c, d, and fin a set Pₘ. Accordingly, the indices b, e, and g may remain in Uₜ. The electronic apparatus may select a lowest index “b” from Uₜ again, and may determine [symbol] _{b,:,:,:} and [symbol] _{e,:,:,:} are similar to each other. Accordingly, the indices b and e may be included in a set Pₘ₊₁, and the last index g remaining in Uₜ may be included in a set P_{O}.

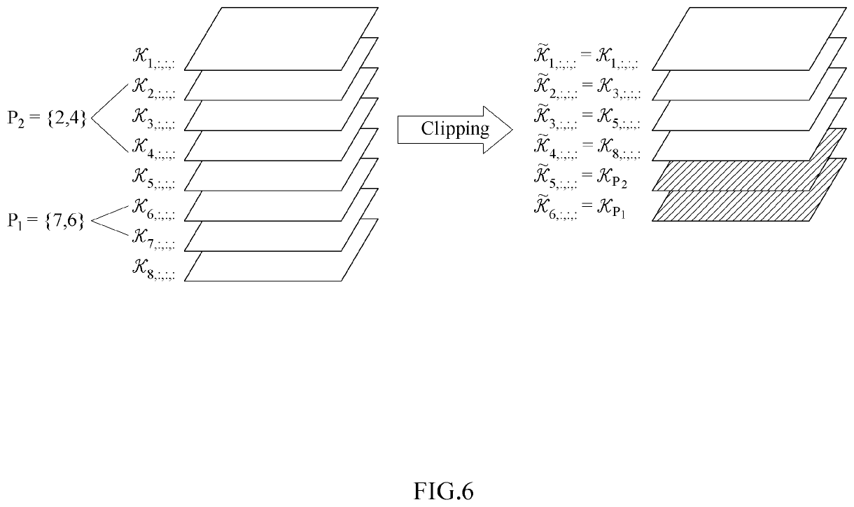

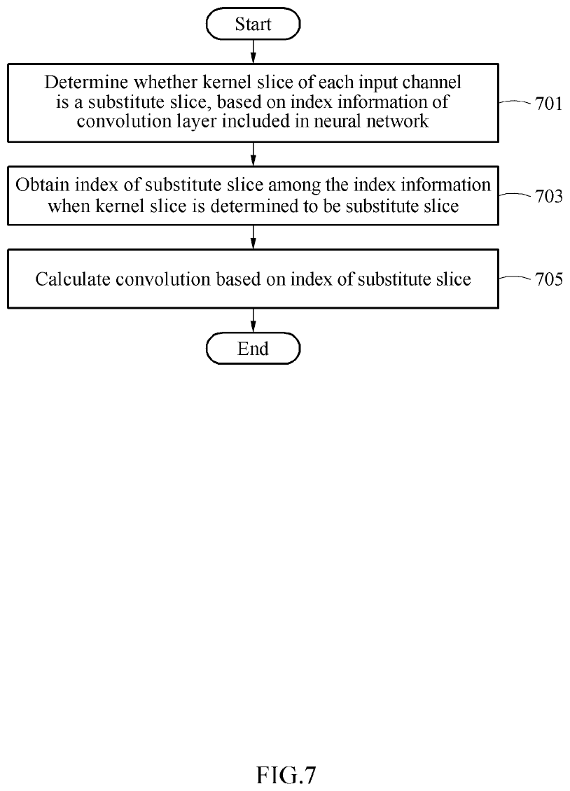

FIG. 6 illustrates an example of clipping a kernel slice similar to a selected kernel slice in a method of clipping a neural network.

An original index of a new convolution kernel [symbol] corresponding to an original convolution kernel K in a dimension of an input channel may increase. An order of indices of original kernel slices that are not clipped in a first portion may not change, and a first index assigned to an average kernel slice in a second portion may also increase in order, and thus calculation may be conveniently performed.

Referring to FIG. 6, the original convolution kernel may include kernel slices of eight input channels. A kernel slice of a second input channel and a kernel slice of a fourth input channel may be similar, and a kernel slice of a sixth input channel and a kernel slice of a seventh input channel may be similar. An electronic apparatus may clip the kernel slices of the sixth input channel and the seventh input channel based on indices included in P₁, and may clip the kernel slices of the second input channel and the fourth input channel based on indices included in P₂. An arrangement order of the remaining kernel slices of the original input channels may remain unchanged in a new convolution kernel obtained after clipping. Subsequently, the electronic apparatus may include an average kernel slice [symbol] _{P}_{₂} corresponding to P₂ in the new convolution kernel, and include an average kernel slice [symbol] _{P}_{₁} corresponding to P₁ in the new convolution kernel. This is because a lowest original index of P₂ is “2” and a lowest original index of P₁ is “6”.

To further facilitate calculation of a subsequent operation, an additional reference structure for recording an index of a kernel slice of the original input channel associated with the new convolutional kernel may be required. In the original kernel slices that are not clipped in the first portion, the original indices may be sequentially recorded in a set P_{O}. In the average kernel slices of the second portion, Pₘ including the original indices may be recorded in a set U in an order of lowest original indices. In FIG. 6, P_{O}={1,3,5,8}, and U={P₂, P₁}.

FIG. 7 illustrates an example of a method of calculating a convolution of a neural network. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer, such as a processor, that perform the specified functions, or combinations of special purpose hardware and computer instructions. In addition to the description of FIG. 7 below, the descriptions of FIGS. 1-6 are also applicable to FIG. 7, and are incorporated herein by reference. Thus, the above description may not be repeated here.

Referring to FIG. 7, in operation 701, an electronic apparatus may determine whether a kernel slice of each input channel is a substitute slice, based on index information of a convolution layer included in the neural network. In operation 703, the electronic apparatus may obtain an index of the substitute slice among the index information when the kernel slice is determined to be the substitute slice. In operation 705, the electronic apparatus may calculate a convolution based on the index of the substitute slice. For example, a kernel slice similar to a kernel slice selected based on a convolution parameter of the convolution layer may be clipped and replaced by the substitute slice.

When the kernel slice is the substitute slice, the electronic apparatus may determine an index of a kernel slice that is clipped and assigned as a substitute slice. The electronic apparatus may perform a convolution operation on a substitute slice corresponding to the determined index. When the kernel slice is not the substitute slice, the electronic apparatus may perform a convolution operation on a corresponding kernel slice using an index of the original kernel slice.

In an example, the electronic apparatus may perform image recognition or speech recognition using the method of FIG. 7. A CNN clipped by the method of FIG. 1 may be used for image recognition or speech recognition.

The electronic apparatus may receive an image or speech through a user input. For example, there is no limitation to a format of the image, and the image may be [symbol] ϵ [symbol] ^{C×w×H}. Here, C, W, and H denote a number of channels of the image, a width of the image, and a height of the image, respectively. Also, [symbol] may include a feature diagram with a size of “W×H” for “C” channels.

The electronic apparatus may input the received image or speech to a first convolution layer of the CNN. For example, the electronic apparatus may input a received image [symbol] ϵ [symbol] ^{C×W×H} to a first convolution layer of a neural network that is clipped. A neural network used for image recognition may be trained in advance based on training data and may be clipped.

The electronic apparatus may traverse convolution layers of the neural network sequentially from the first convolution layer. The electronic apparatus may determine whether a kernel slice of each input channel is a substitute slice based on an index of the kernel slice.

In an example, when a kernel slice of an input channel is a substitute slice, the electronic apparatus may obtain an index of a kernel slice that is clipped and replaced by the substitute slice, and may perform a convolution calculation based on the index.

The electronic apparatus may determine substitute slices based on indices indicating the substitute slices, may perform a sum calculation of the determined substitute slices, and may perform a convolution operation on kernel slices and a result of the sum calculation, to perform a convolution operation in the clipped neural network.

In another example, when a kernel slice of an input channel is not a substitute slice, the electronic apparatus may determine a kernel slice corresponding to an index of a convolution input channel, and may perform a convolution calculation on the determined kernel slice.

The electronic apparatus may output a cumulative value obtained by accumulating results of convolution calculations of kernel slices of all input channels of a convolution layer as an output result of the convolution layer. The electronic apparatus may output an output result of a last convolution layer of the neural network as an image recognition result or a speech recognition result.

The electronic apparatus may use the clipped neural network to perform a convolution operation, and thus it is possible to lessen complexity of calculation and complexity of a neural network used for image recognition or speech recognition, to reduce a storage space of the neural network, and to ease requirements for an operating environment of the neural network.

For example, the electronic apparatus may sequentially traverse kernel slices [symbol] _{s,:,:,:}ϵ [symbol] ^{1×S×w×h}(sϵ{1, 2, . . . , C−Σₘ nₘ+M}) of input channels of a clipped convolution kernel [symbol] . 1≤s≤C−Σ_{M} nₘ may indicate that a kernel slice of a corresponding input channel corresponds to the original convolution kernel [symbol] . Since an index in the original convolution kernel may be P_{O}(s) is an s-th element of the set P_{O}, the electronic apparatus may perform a general convolution operation on a P_{O}(s)-th kernel slice [symbol] _{s,:,:,:} of an input channel, to obtain an output [symbol] _{P}_{_{O}}_{(s),:,:}* [symbol] _{s,:,:,:}= [symbol] ^{(s)}ϵ [symbol] ^{S×(W-w+1)×(H-h+1)} of a corresponding iteration. C−Σ_{M} nₘ<s≤C−Σ_{M} nₘ+M may indicate that a kernel slice of a corresponding input channel is a (s−C+Σₘ nₘ)-th kernel slice among “M” average kernel slices [symbol] _{P}_{ₘ}. The electronic apparatus may read a (s−C+Σₘ nₘ)-th element Pₘ, and may read indices pϵPₘ of all original kernel slices in Pₘ again. The electronic apparatus may sum all p-th kernel slices [symbol] _{p,:,:}ϵ [symbol] ^{1×W×H} of input channels and may perform a general convolution with [symbol] _{s,:,:,:}, to obtain an output (Σ_{pϵP}_{ₘ} [symbol] _{p,:,:,:})* [symbol] _{s,:,:,:}= [symbol] ^{(s)}ϵ [symbol] ^{S×(W-w+1)×(H-h+1)} of a corresponding iteration. An output obtained by adding all C−Σ_{M} nₘ+M [symbol] [symbol] ^{(s)} may be identical to the original convolution output [symbol] ϵ [symbol] ^{S×(W-w+1)×(H-h+1)}, and [symbol] = [symbol] * [symbol] ≈ [symbol] [symbol] [symbol] =Σ_{sϵ{1, 2, . . . , C-Σ}_{_{M}}ₙ_{ₘ}_{+M}} [symbol] ^{(s)}.

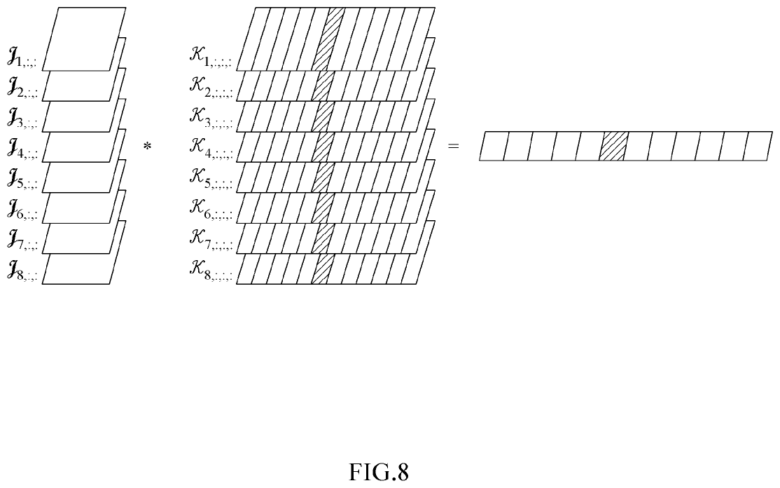

FIG. 8 illustrates an example of a general convolution operation.

The general convolution operation may include a process of obtaining a single output feature diagram by allowing all input feature diagrams to participate in an operation each time and of finally summing all output feature diagrams. In a convolution operation according to an example, all output feature diagrams may be obtained by allowing a single input feature diagram to participate in an operation each time, however, information of the output feature diagrams may be incomplete. Thus, the convolution operation may include a process of overlapping output feature diagrams with each other after traversing all input feature diagrams.

In the general convolution operation, convolution operations may be performed on all input feature diagrams and a portion of kernel slices of input channels corresponding to the input feature diagrams, results of the convolution operations may be summed, and an output feature diagram may be obtained. Referring to FIG. 8, “8” input feature diagrams may be converted into “12” output feature diagrams through a convolution. Each general convolution operation may be performed on a hatched portion of a convolution kernel and an input feature diagram that is the same as an index of an input channel corresponding to the hatched portion, results of general convolution operations may be summed, and a sixth output feature diagram indicated by a hatched pattern may be obtained.

In an example, an electronic apparatus may perform a convolution of a single input feature diagram, for example, [symbol] _{1,:,:}, and each of “12” portions of [symbol] _{1,:,:,:} of an index of the same input channel in sequence, to obtain a tensor [symbol] ⁽¹⁾, that is [symbol] _{1,:,:}* [symbol] _{1,:,:,:}= [symbol] ⁽¹⁾, including “12” output feature diagrams. Subsequently, the electronic apparatus may traverse all input feature diagrams, to obtain “8” output tensors, each including “12” output feature diagrams. The “8” output tensors may be [symbol] ⁽¹⁾, [symbol] ⁽²⁾, . . . , [symbol] ⁽⁸⁾. Finally, the electronic apparatus may obtain [symbol] =Σ_{s=1, 2, . . . , 8} [symbol] ^{(s)} that is the same output as that of the general convolution operation, by summing the “8” output tensors.

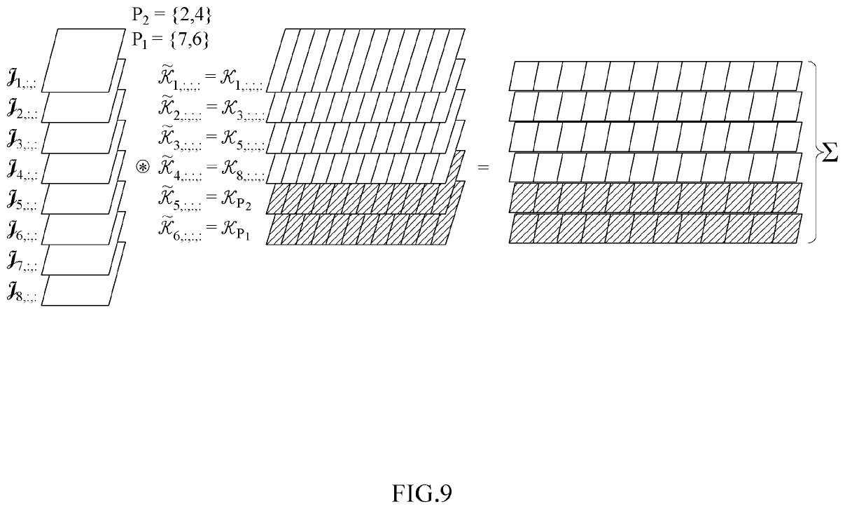

FIG. 9 illustrates an example of a method of calculating a convolution of a neural network.

A clipping result for a convolution kernel of FIG. 9 may be the same as that of FIG. 8, P_{O}=(1,3,5,8), U={P₂, P₁}, Σₘ nₘ=2+2=4, and M=2. Kernel slices of input channels of a clipped convolution kernel [symbol] may be sequentially traversed. Since a kernel slice [symbol] _{1,:,:,:} is included in the original convolution kernel and since the original index is P_{O}(1)=1, [symbol] _{1,:,:}* [symbol] _{1,:,:,:}= [symbol] ⁽¹⁾ may be obtained when a convolution operation on the kernel slice [symbol] _{1,:,:,:} and [symbol] _{1,:,:} is performed. Since a kernel slice [symbol] _{2,:,:,:} is included in the original convolution kernel and since the original index is P_{O}(2)=3, [symbol] _{3,:,:}* [symbol] _{2,:,:,:}= [symbol] ⁽²⁾ may be obtained when a convolution operation on the kernel slice [symbol] _{2,:,:,:} and [symbol] _{3:,:} is performed. Since a kernel slice [symbol] _{3,:,:,:} is included in the original convolution kernel and since the original index is P_{O}(3)=5, [symbol] _{5:,:}* [symbol] _{3,:,:,:}= [symbol] ⁽³⁾ may be obtained when a convolution operation on the kernel slice [symbol] _{3,:,:,:} and [symbol] _{5:,:} is performed. Since a kernel slice [symbol] _{4,:,:,:} is included in the original convolution kernel and since the original index is P_{O}(4)=8, [symbol] _{8,:,:}* [symbol] _{4,:,:,:}= [symbol] ⁽⁴⁾ may be obtained when a convolution operation on the kernel slice [symbol] _{4,:,:,:} and [symbol] _{8:,:} is performed. A kernel slice [symbol] _{5:,:,:} may be derived from a first average kernel slice among two average kernel slices, and the electronic apparatus may read a first element P₂ from U and may obtain the original index {2,4} in P₂. The electronic apparatus may perform a convolution operation on the kernel slice [symbol] _{5,:,:,:} and a sum of [symbol] _{2:,:} and [symbol] _{4:,:}, to obtain ( [symbol] _{2:,:}+ [symbol] _{4:,:})* [symbol] _{5,:,:,:}= [symbol] ⁽⁵⁾. A kernel slice [symbol] _{6,:,:,:} may be derived from a second average kernel slice among the two average kernel slices, and the electronic apparatus may read a second element P₁ from U and may obtain the original index {7,6} in P₁. The electronic apparatus may perform a convolution operation on the kernel slice [symbol] _{6,:,:,:} and a sum of [symbol] _{6:,:} and [symbol] _{7:,:}, to obtain ( [symbol] _{6:,:}+ [symbol] _{7:,:})* [symbol] _{6,:,:,:}= [symbol] ⁽⁶⁾. The electronic apparatus may obtain an approximate value [symbol] ≈ [symbol] ⁽¹⁾+ [symbol] ⁽²⁾+ [symbol] ⁽³⁾+ [symbol] ⁽⁴⁾+ [symbol] ⁽⁵⁾+ [symbol] [symbol] ⁽⁶⁾, because an average kernel slice is substitute for a kernel slice of the original input channel that is clipped. [symbol] _{5,:,:,:} and [symbol] _{6,:,:,:} may be associated with two input feature diagrams, respectively. The electronic apparatus may perform a next convolution after calculating a sum of input feature diagrams. Thus, a number of convolution operations may be reduced and efficiency of calculation may be increased.

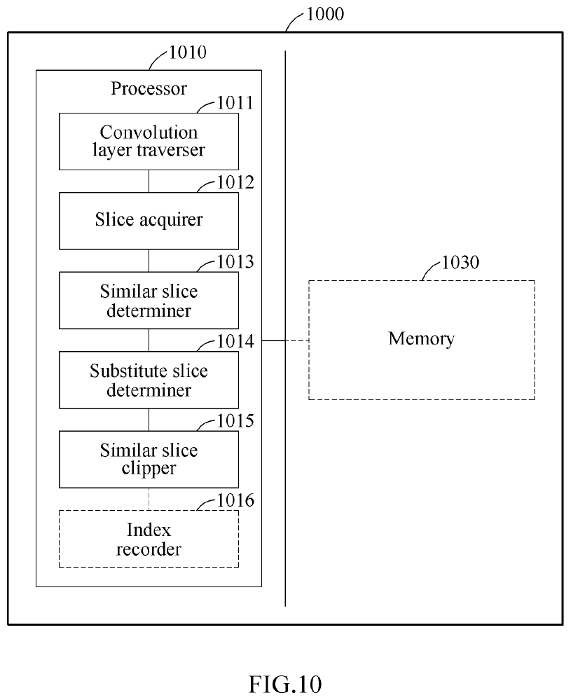

FIG. 10 illustrates an example of a configuration of an electronic apparatus 1000.

Referring to FIG. 10, the electronic apparatus 1000 may include at least one processor 1010. The electronic apparatus 1000 may further include a memory 1030. The memory 1030 may store a neural network, and data used to operate the neural network. The memory 1030 may also store input data to be input to the neural network, and output data that is output from the neural network.

The processor 1010 may select a kernel slice of an input channel of a convolution layer included in the neural network based on a convolution parameter of the convolution layer. The convolution parameter may include a number of input channels of the convolution layer, a number of output channels, and a width and a height of a filter of a convolution kernel of the convolution layer.

The processor 1010 may determine at least one kernel slice similar to the selected kernel slice. The processor 1010 may determine a substitute slice for the selected kernel slice, based on the least one kernel slice. The processor 1010 may clip the selected kernel slice and replace the clipped kernel slice by the substitute slice.

The processor 1010 may be a hardware-implemented image apparatus for clipping a neural network and for calculating a convolution of the neural network having a circuit that is physically structured to execute desired operations. For example, the desired operations may include code or instructions included in a program. The hardware-implemented clipping and convolution apparatus may include, for example, a microprocessor, a central processing unit (CPU), single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, a processor core, a multi-core processor, and a multiprocessor, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner. Further description of the processor 1010 is given below.

The memory 1030 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory may be implemented as electrically erasable programmable read-only memory (EEPROM), a flash memory, magnetic ram (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), a holographic memory, molecular electronic memory device, or insulator resistance change memory. Further description of the memory 1030 is given below.

In an example, the processor 1010 may be configured to implement a convolution layer traverser 1011, a slice acquirer 1012, a similar slice determiner 1013, a substitute slice determiner 1014, and a similar slice clipper 1015. The convolution layer traverser 1011, the slice acquirer 1012, the similar slice determiner 1013, the substitute slice determiner 1014, and the similar slice clipper 1015 may be implemented as at least one processor 1010, or may be implemented as software instructions that are stored in the memory 1030, and which configure the processor 1010 to perform the functions of the convolution layer traverser 1011, the slice acquirer 1012, the similar slice determiner 1013, the substitute slice determiner 1014, and the similar slice clipper 1015.

The convolution layer traverser 1011 may be configured to traverse each convolution layer of a neural network. The slice acquirer 1012 may be configured to acquire a kernel slice of an input channel based on a convolution parameter of a convolution layer.

The slice acquirer 1012 may be configured to determine a number of kernel slices of input channels based on a number of input channels of a convolution kernel. The slice acquirer 1012 may be configured to extract a kernel slice of an input channel from a tensor representing the convolution kernel based on the convolution parameter according to the determined number of kernel slices.

The similar slice determiner 1013 may be configured to determine a kernel slice similar to a kernel slice selected from kernel slices of input channels.

The similar slice determiner 1013 may be configured to calculate norms of kernel slices for each input channel and to determine a kernel slice similar to a kernel slice selected from kernel slices of input channels based on the norms.

The substitute slice determiner 1014 may be configured to determine a substitute slice for a kernel slice similar to a kernel slice selected from kernel slices of input channels.

The substitute slice determiner 1014 may be configured to calculate an average kernel slice from among kernel slices similar to a selected kernel slice and to determine the average kernel slice as a substitute slice. The substitute slice determiner 1014 may be configured to determine one of kernel slices similar to a selected kernel slice as a substitute slice.

The substitute slice determiner 1014 may be configured to classify kernel slices of input channels based on a similarity between norms, to traverse each class of a classification result, to calculate a similarity between the kernel slices, and to determine a kernel slice similar to a selected kernel slice based on the calculated similarity.

The substitute slice determiner 1014 may be configured to obtain a similarity between kernel slices of input channels by calculating a norm of a difference between the kernel slices, and to determine a kernel slice, of which a similarity to the selected kernel slice is within a threshold as a kernel slice similar to the selected kernel slice.

The similar slice clipper 1015 may be configured to clip a kernel slice similar to a selected kernel slice, and to replace the clipped kernel slice with a substitute slice.

The electronic apparatus may further include an index recorder 1016. The index recorder 1016 may be configured to record an index of a kernel slice of an input channel that is clipped and replaced by a substitute slice. Accordingly, the electronic apparatus may record a clipped kernel slice of each input channel using an index.

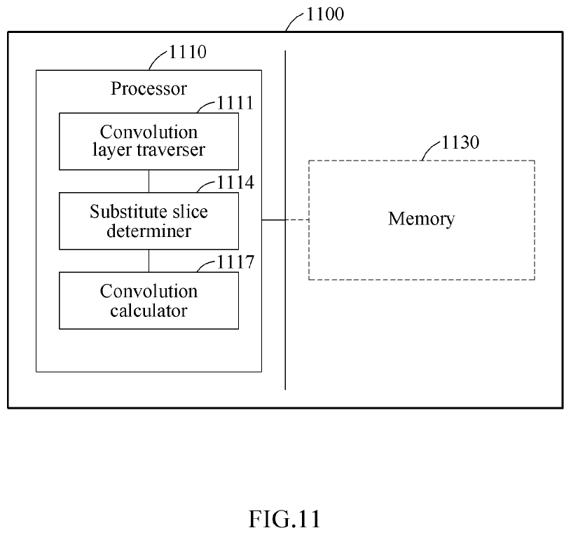

FIG. 11 illustrates an example of a configuration of an electronic apparatus 1100.

Referring to FIG. 11, the electronic apparatus 1100 may include at least one processor 1110. The electronic apparatus 1000 may further include a memory 1130. The memory 1130 may store a neural network, and data used to operate the neural network. The memory 1130 may also store input data to be input to the neural network, and output data that is output from the neural network.

The processor 1110 may be a hardware-implemented apparatus for traversing a neural network and for calculating a convolution of the neural network, which has a circuit that is physically structured to execute desired operations. For example, the desired operations may include code or instructions included in a program. The hardware-implemented generation apparatus may include, for example, a microprocessor, a central processing unit (CPU), single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, a processor core, a multi-core processor, and a multiprocessor, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner. Further description of the processor 1110 is given below.

The memory 1130 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory may be implemented as electrically erasable programmable read-only memory (EEPROM), a flash memory, magnetic ram (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), a holographic memory, molecular electronic memory device, or insulator resistance change memory. Further description of the memory 1130 is given below.

In an example, the processor 1110 may be configured to implement a convolution layer traverser 1111, a substitute slice determiner 1114, and a convolution calculator 1117. The convolution layer traverser 1111, the substitute slice determiner 1114, and the convolution calculator 1117 may be implemented as at least one processor 1110, or may be implemented as software instructions that are stored in the memory 1130, and which configure the processor 1110 to perform the function of the convolution layer traverser 1111, the substitute slice determiner 1114, and the convolution calculator 1117.

The convolution layer traverser 1111 may be configured to traverse each convolution layer of a neural network.

The substitute slice determiner 1114 may be configured to determine whether a kernel slice of each input channel of a convolution layer is a substitute slice, based on an index of the kernel slice.

When a kernel slice of an input channel is determined to be a substitute slice, the convolution calculator 1117 may be configured to obtain an index of a kernel slice of an input channel that is clipped and replaced by the substitute slice and to perform a convolution operation based on the index.

The convolution calculator 1117 may be configured to determine kernel slices corresponding to indices of kernel slices of input channels that are replaced by substitute slices, to perform a sum calculation of the determined kernel slices, and to perform a convolution operation on the kernel slices and a result of the sum calculation.

When the kernel slice is determined not to be the substitute slice, the convolution calculator 1117 may be configured to determine a kernel slice corresponding to an index of the original kernel slice of an input channel, and to perform a convolution calculation on a kernel slice corresponding to an index of the determined kernel slice.

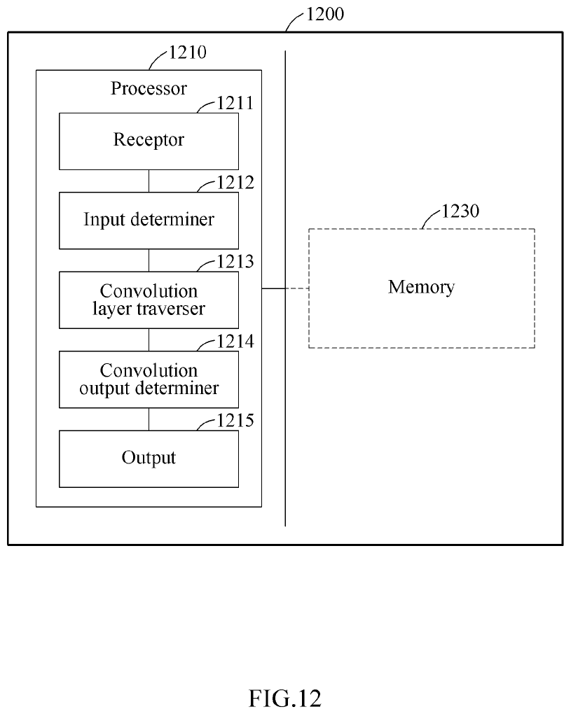

FIG. 12 illustrates an example of a configuration of an electronic apparatus 1200.

Referring to FIG. 12, the electronic apparatus 1200 may include at least one processor 1210. The electronic apparatus 1000 may further include a memory 1230. The memory 1230 may store a neural network, and data used to operate the neural network. The memory 1230 may also store input data to be input to the neural network, and output data that is output from the neural network.

The processor 1210 may be a hardware-implemented apparatus for traversing a neural network and for calculating a convolution of the neural network, which has a circuit that is physically structured to execute desired operations. For example, the desired operations may include code or instructions included in a program. The hardware-implemented generation apparatus may include, for example, a microprocessor, a central processing unit (CPU), single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, a processor core, a multi-core processor, and a multiprocessor, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner. Further description of the processor 1210 is given below.

The memory 1230 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory may be implemented as electrically erasable programmable read-only memory (EEPROM), a flash memory, magnetic ram (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), a holographic memory, molecular electronic memory device, or insulator resistance change memory. Further description of the memory 1230 is given below.

In an example, the processor 1210 may be configured to implement a receptor 1211, an input determiner 1212, a convolution layer traverser 1213, a convolution output determiner 1214, and a output 1215. The receptor 1211, the input determiner 1212, the convolution layer traverser 1213, the convolution output determiner 1214, and the output 1215 may be implemented as at least one processor 1210, or may be implemented as software instructions that are stored in the memory 1130, and which configure the processor 1110 to perform the function of the receptor 1211, the input determiner 1212, the convolution layer traverser 1213, the convolution output determiner 1214, and the output 1215.

The receptor 1211 may be configured to receive an image and/or speech of a user.

The input determiner 1212 may be configured to use the received image and/or speech as an input of a first convolution layer of a neural network.

The convolution layer traverser 1213 may be configured to traverse each convolution layer of the neural network.

The convolution output determiner 1214 may be configured to determine whether a kernel slice of each input channel of a convolution layer is a substitute slice, based on an index of the kernel slice.

When a kernel slice of an input channel is determined to be a substitute slice, the convolution output determiner 1214 may be configured to obtain an index of a kernel slice that is clipped and replaced by the substitute slice, to perform a convolution operation based on the index, and to output a cumulative value obtained by accumulating results of convolution operations of kernel slices of all input channels as an output result of a convolution operation of the convolution layer.

The convolution output determiner 1214 may be configured to determine kernel slices corresponding to indices of kernel slices of input channels that are replaced by substitute slices, to perform a sum calculation of kernel slices corresponding to indices of kernel slices that are clipped and replaced by the determined kernel slices, and to perform a convolution operation on the kernel slices and a result of the sum calculation, so that a convolution operation may be implemented in a clipped neural network.

When the kernel slice is determined not to be the substitute slice, the convolution output determining unit may be configured to determine a kernel slice corresponding to an index of the original kernel slice of an input channel, and to perform a convolution calculation on a kernel slice of an input channel and a kernel slice corresponding to an index of the determined kernel slice.

The output 1215 may be configured to use an output of a last convolution layer of the neural network as a result of the image recognition or speech recognition.

Each of the electronic devices 1000, 1100, and 1200 that perform one or more of the operation of traversing a convolution layer of a neural network, clipping a kernel slice, determining whether a kernel slice of each input channel of the convolution layer is a substitute slice, performing a convolution calculation on the kernel slice, and outputting an output of a last convolution layer of the neural network as a result of the image recognition or speech recognition may each perform all or some of these operation. In another example, each of the electronic devices 1000, 1100, and 1200 may only perform operation that are described with reference to each of these devices in FIGS. 10-12 above.

The electronic apparatus 1000, the electronic apparatus 1100, the electronic apparatus 1200, the convolution layer traverser 1011, the slice acquirer 1012, the similar slice determiner 1013, the substitute slice determiner 1014, and the similar slice clipper 1015, the convolution layer traverser 1111, the substitute slice determiner 1114, the convolution calculator 1117, receptor 1211, the input determiner 1212, the convolution layer traverser 1213, the convolution output determiner 1214, the output 1215, and other apparatuses, units, modules, devices, and components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In an example, the instructions or software includes at least one of an applet, a dynamic link library (DLL), middleware, firmware, a device driver, an application program storing the method of generating an image and the method of training a neural network. In another example, the instructions or software include higher-level code that is executed by the processor or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), magnetic RAM (MRAM), spin-transfer torque(STT)-MRAM, static random-access memory (SRAM), thyristor RAM (T-RAM), zero capacitor RAM (Z-RAM), twin transistor RAM (TTRAM), conductive bridging RAM(CBRAM), ferroelectric RAM (FeRAM), phase change RAM (PRAM), resistive RAM(RRAM), nanotube RRAM, polymer RAM (PoRAM), nano floating gate Memory(NFGM), holographic memory, molecular electronic memory device), insulator resistance change memory, dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In an example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method of clipping a neural network, the method comprising:
selecting a kernel slice of an input channel of a convolution layer in the neural network based on a convolution parameter of the convolution layer;
determining a kernel slice similar to the selected kernel slice;
determining a substitute slice for the selected kernel slice, based on the similar kernel slice; and
clipping the selected kernel slice and replacing the clipped kernel slice by the substitute slice,
wherein the convolution parameter comprises a number of input channels of the convolution layer, a number of output channels, and a width and a height of a filter of a convolution kernel of the convolution layer.

2. The method of claim 1, further comprising:
storing an index of the clipped kernel slice.

3. The method of claim 1, wherein the determining of the similar kernel slice comprises:
calculating norms of kernel slices for each of the input channels of the convolution layer; and
determining a kernel slice similar to the selected kernel slice, based on the norms.

4. The method of claim 3, wherein the determining of the kernel slice similar to the selected kernel slice comprises:
classifying kernel slices of the input channels into at least one class based on the norms; and
determining a kernel slice from among kernel slices within a class of the selected kernel slice based on a similarity between the selected kernel slice and each of the kernel slices within the class.

5. The method of claim 4, wherein the determining of the kernel slice based on the similarity comprises:
determining the similarity by calculating a norm of a difference between the selected kernel slice and each of the kernel slices within the class; and
determining a kernel slice having a similarity to the selected kernel slice lesser than or equal to a threshold, as the similar kernel slice.

6. The method of claim 1, wherein the determining of the substitute slice comprises:
calculating an average kernel slice by averaging the selected kernel slice and the similar kernel slice; and
replacing any one or any combination of the selected kernel slice and the similar kernel slice by the average kernel slice.

7. The method of claim 1, wherein the selecting of the kernel slice comprises:
determining a number of kernel slices based on the number of input channels; and
extracting the kernel slice of the input channel from a tensor representing the convolution kernel based on the number of kernel slices and the convolution parameter.

8. A non-transitory computer-readable storage medium storing instructions that, when executed by a processor, cause the processor to perform the method of claim 1.

9. A processor-implemented method of convolution of a neural network, the method comprising:
determining whether a kernel slice of each input channel is a substitute slice, based on index information of a convolution layer included in the neural network;
obtaining an index of the substitute slice from the index information, in response to the kernel slice being the substitute slice; and
calculating a convolution based on the index of the substitute slice,
wherein a first kernel slice, similar to a second kernel slice, selected based on a convolution parameter of the convolution layer is clipped and replaced by the substitute slice.

10. The method of claim 9, further comprising:
performing a convolution on the kernel slice using an index of the kernel slice, in response to the kernel slice not being the substitute slice.

11. The method of claim 10, further comprising:
outputting a cumulative value obtained by accumulating results of the calculating of the convolution and the performing of the convolution for kernel slices of input channels of the convolution layer as an output of the convolution layer.

12. An electronic apparatus comprising:
a processor configured to:
select a kernel slice of an input channel of a convolution layer in a neural network based on a convolution parameter of the convolution layer;
determine a kernel slice similar to the selected kernel slice;
determine a substitute slice for the selected kernel slice, based on the similar kernel slice; and
clip the selected kernel slice and replace the clipped kernel slice by the substitute slice,
wherein the convolution parameter comprises a number of input channels of the convolution layer, a number of output channels, and a width and a height of a filter of a convolution kernel of the convolution layer.

13. The apparatus of claim 12, wherein the processor is further configured to:
classify kernel slices of the input channels into one or more classes based on the norms of kernel slices for each of the input channels of the convolution layer; and
determine a kernel slice, from among kernel slices within a class of the selected kernel slice, to be the similar kernel slice based on a similarity between the selected kernel slice and each of the kernel slices within the class.
